(19) United States
(12) Patent Application Publication
(10) Pub. No.: US 2006/0088810 A1
(43) Pub. Date: Apr. 27, 2006

(54) Karaoke audio-visual recorder/player

(76) Inventor: Ming-Hsiang Yeh, Taipei City (TW)

Correspondence Address: TROXELL LAW OFFICE PLLC;SUITE 1404, 5205 LEESBURG PIKE, FALLS CHURCH, VA, 22041, US

(21) Appl. No.: 10/968,939

(22) Filed: Oct. 21, 2004

(51) Int. Cl. G10H 1/36; G10H 7/00

(52) U.S. Cl. 434/307 A

(57) ABSTRACT

A karaoke audio-visual recorder/player having a main body is disclosed, wherein a microphone is mounted on one side of the main body, and a monitor, a band selection button, a plurality of function buttons, an output/input device, a camera lens, and a storage device are mounted on the other side of the main body. The band selection button has the same frequency as a karaoke machine that shows songs so as to sing the songs by means of the microphone at any places and record sound and images in the storage device by means of the microphone and the camera lens. The sound and the images can be transmitted to other equipment through the output/input device for being edited and stored.

### BACKGROUND OF THE INVENTION

The present invention relates to a karaoke audio-visual recorder/player that is suitable for an individual, a family, or a place likes that so as to enable user to sing, view, or listen to music.

Nowadays, with the increasing of people's income, people have paid more and more attention to leisure life. Singing a song is a kind of leisure entertainment that is widely accepted by people. The place that can be used to sing a song is a karaoke store having a lot of people therein or the large or small staterooms provided by such as Holiday Ltd., Cashbox Ltd., etc. However, the numbers of microphone in all of these places are limited. Especially for the karaoke store, if there are too many customers in the store, then the customers who have ordered songs for singing have to wait by turns according to their table numbers. Therefore, these customers usually wait for a long time but sing no song.

Furthermore, only few places provide services of sound and film recording for customers. Even these services are provided, the customers are charged very high price, except the customer who carries V8 to take a tape for memory. This tape is only used for showing and cannot applied to other application.

Whereas the aforementioned drawbacks of the conventional structure, the present inventor has been made diligent studies with a quiet mind to design and fabricate a karaoke audio-visual recorder/player for consumers. The karaoke audio-visual recorder/player has audio-visual recording function and can be used as a microphone.

### SUMMARY OF THE INVENTION

The main purpose of the present invention is to provide a karaoke audio-visual recorder/player for use alone without sharing with other person so as to sing songs at any moment and place.

Another purpose of the present invention is to provide a karaoke audio-visual recorder/player that has the audio-visual recording function.

Still another purpose of the present invention is to provide a karaoke audio-visual recorder/player that can be used to view and edit the recorded data by means of transmission of a transmitter.

According to the aforementioned purposes of the present invention, a karaoke audio-visual recorder/player having a main body is disclosed, wherein a microphone is mounted on one side of the main body, and a monitor, a band selection button, a plurality of function buttons, an output/input device, a camera lens, and a storage device are mounted on the other side of the main body. The band selection button has the same frequency as a karaoke machine that shows songs so as to sing the songs by means of the microphone at any places and record sound and images in the storage device by means of the microphone and the camera lens. The sound and the images can be transmitted to other equipment through the output/input device for being edited and stored.

The other features and preferred embodiments of the present invention will now be described with reference to the accompanying drawings.

### BRIEF DESCRIPTION OF THE DRAWINGS

FIG. 1 is a perspective view showing an outward appearance of a preferred embodiment of the present invention.

FIG. 2 is a circuit diagram in accordance with the preferred embodiment of the present invention.

FIG. 3 is a schematic view showing one usage of the preferred embodiment of the present invention.

FIG. 4 is a schematic view showing another usage of the preferred embodiment of the present invention.

FIG. 5 is a schematic view showing still another usage of the preferred embodiment of the present invention.

### DETAILED DESCRIPTION OF THE PREFERRED EMBODIMENT

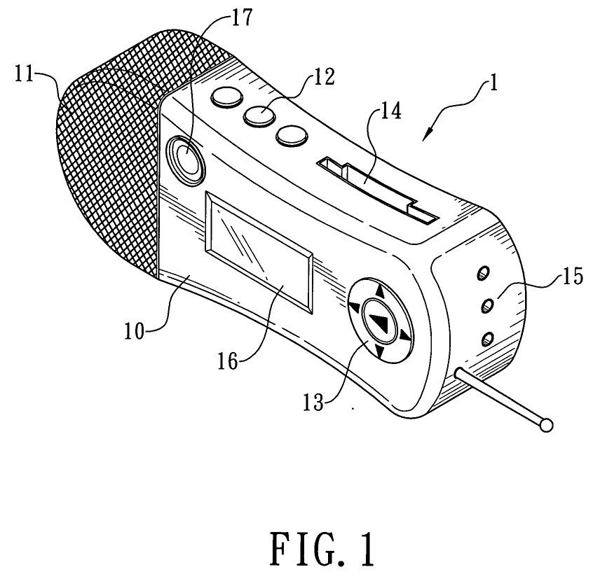

Referring to FIG. 1, the karaoke audio-visual recorder/player 1 of the present invention comprises a main body 10. A microphone 11 is mounted on one side of the main body 10. A camera lens 17, a monitor 16, a plurality of function buttons 12, a band selection button 13, an input/output device 15, and a storage device 14 are mounted on the fringe of the other side of the main body 10.

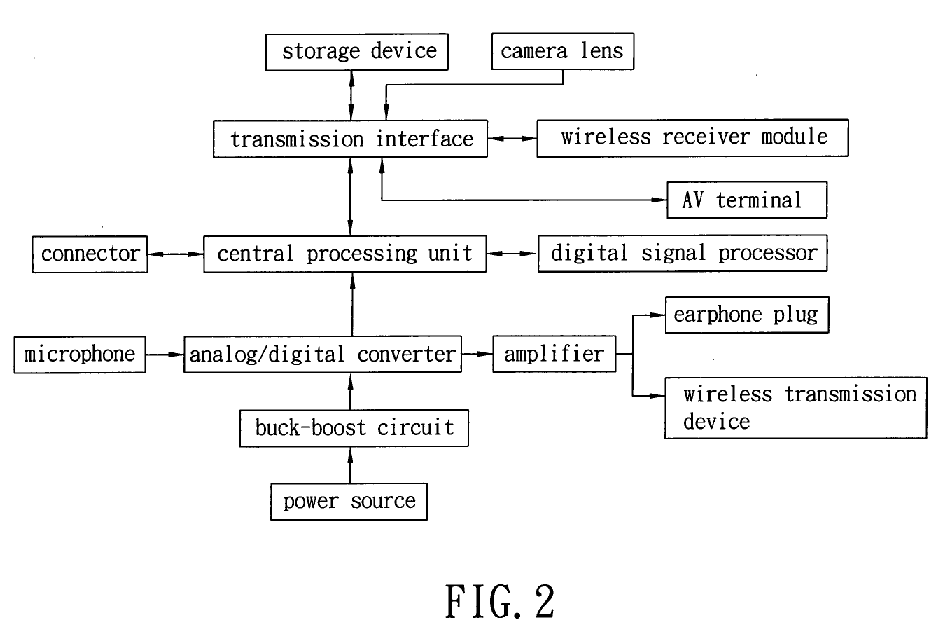

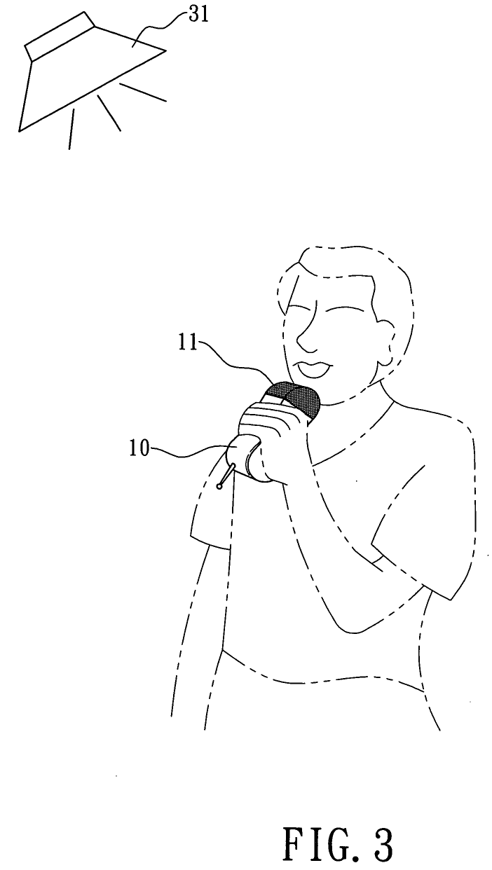

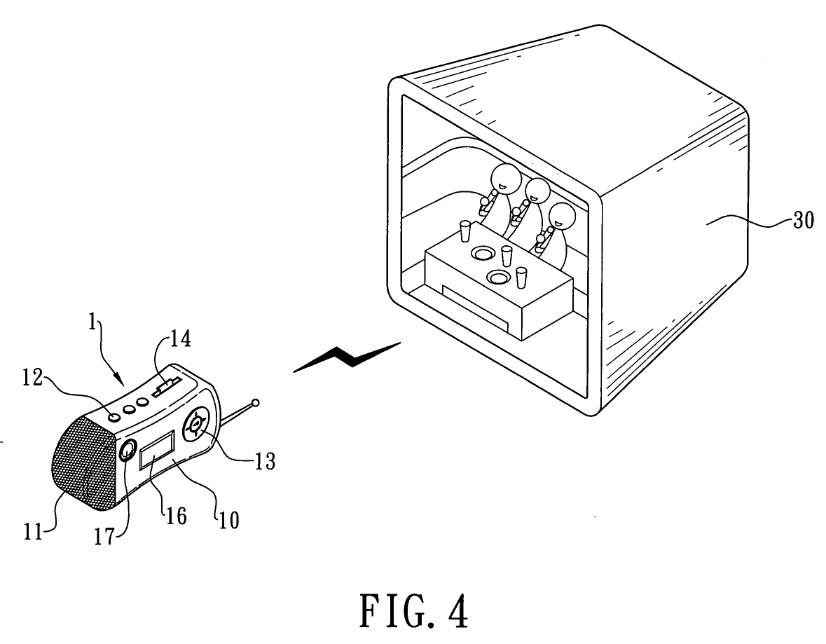

Referring to both FIG. 2 and FIG. 3, when the present invention is in use, the band selection button 13 on the main body 10 is switched to have the same frequency as an audio-visual equipment 30 (as shown in FIG. 4). A central processing unit (CPU) mounted in the main body 10 utilizes an analog/digital converter to process the sound that is inputted from the microphone 11. A signal that is amplified by the amplifier is then transmitted to a speaker 31 of the audio-visual equipment 30 through a wireless transmission device such that the present invention can be utilized for signing at any place. In addition, when the camera lens 17 on the main body 10 is utilized for taking a film, the wireless receiver module can receive the sound sent from the speaker. The sound and image data are then transmitted through a transmission interface and stored into the storage device 14. The karaoke audio-visual recorder/player is able to connect to a computer through a USB connector so as to edit and modify data through editing software. In addition, the data can be burnt to form a readily observable compact disc (CD).

In order to view the data that are not burnt into a CD, when, if the audio-visual equipment 30 includes the wireless transmitter/receiver, then the karaoke audio-visual recorder/player 1 of the present invention can utilize the built-in wireless receiver module to transmit the data to the audio-visual equipment 30 so as to view thereof, as shown in FIG. 4. However, if the audio-visual equipment 30 does not include wireless transmitter/receiver, then the output/input device 15 on the main body 10 can be connected to the audio-visual equipment 30 through an AV terminal so as to view the recorded film.

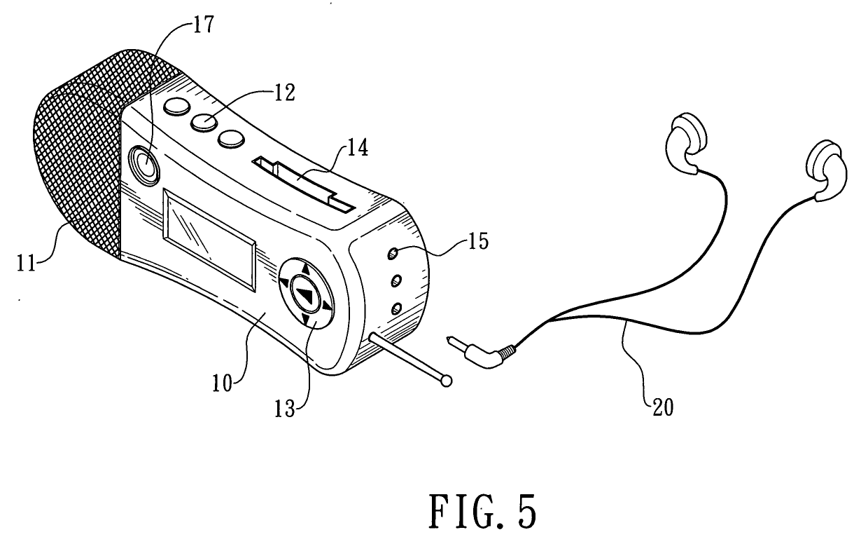

Referring to FIG. 5, when user is in a place that has no audio-visual equipment located thereon, then the user can utilize an earphone 20 to listen to music stored in the karaoke audio-visual recorder/player 1. Furthermore, the output/input device 15 of the present invention can equip with a FM transmitter module. A selection switch for selecting the way of listening to music can be mounted on the outside of the main body 10 such that the earphone 20 can be chosen for listening to music in a public place so as to prevent from interfering with other people.

When the user is at a private space, for example, self-driving car or residence, because other people will not be interfered with and it is more inconvenient to wear the earphone, the selection switch can be turned to the FM transmitter module, and a car audio or a bedside audio can be actuated and turned to a FM (frequency modulation) channel. At the same time, the function buttons on the main body 10 can be pressed so as to search an unused FM channel. After the unused FM channel is found, the monitor 16 shows address of the founded channel and the stored music is then transmitted outwardly. The user just needs to turn the broadcast channel of the car audio or the bedside channel to the frequency of the founded channel. The car audio or the bedside audio will broadcast the music stored in the karaoke audio-visual recorder/player 1. Therefore, when the user is located at the private space, he does not need to wear the earphone and he still can clearly listen to the music stored in the karaoke audio-visual recorder/player 1.

However, the above description merely illustrates the preferred embodiments of the present invention, and the applicable scope of the present invention is not limited hereto. Any obvious modification and revision made by a person skilled in the art are included within the spirit and scope of the present invention.

As described above, the present invention can achieve the expected purpose of the present invention to provide with a karaoke audio-visual recorder/player that can be used for singing alone at any places without sharing with other people and can retain the audio-visual data to have a lovely memory. The application that complies with utility is therefore submitted for a patent.

What the invention claimed is:

1. A karaoke audio-visual recorder/player comprising: a main body, wherein a microphone is mounted on one side of the main body, and a monitor, a band selection button, a plurality of function buttons, an output/input device, a camera lens, and a storage device are mounted on the other side of the main body, wherein the band selection button has the same frequency as a karaoke machine that shows a song so as to sing the song by means of the microphone at any places and store sound and images in the storage device by means of the microphone and the camera lens, and the sound and the images can be transmitted to other equipment through the output/input device for being edited and stored.

2. The karaoke audio-visual recorder/player of claim 1, wherein the output/input device comprises a USB connector, a wireless transmission device, an earphone socket, and an audio-visual transmission socket.

3. The karaoke audio-visual recorder/player of claim 2, wherein the wireless transmission device further comprises a FM transmitter module.
